(19) United States
(12) Patent Application Publication
(10) Pub. No.: US 2026/0358832 A1
(43) Pub. Date: Nov. 12, 2026

(54) MANAGEMENT SYSTEM FOR WORK SITE AND MANAGEMENT METHOD FOR WORK SITE

(71) Applicant: KOMATSU LTD., Tokyo (JP)

(72) Inventor: Kaito CHIBA, Tokyo (JP)

(21) Appl. No.: 19/142,256

(22) PCT Filed: Dec. 25, 2023
(86) PCT No.: PCT/JP2023/046426

§ 371 Date: Jun. 23, 2025

(30) Foreign Application Priority Data
Dec. 26, 2022 (JP) 2022-208439

(51) Int. Cl. G05D 1/693; G05D 1/633; G05D 107/90; G05D 109/10

(52) U.S. Cl. CPC G05D 1/693; G05D 1/633; G05D 2107/90; G05D 2109/10

(57) ABSTRACT

A management system for a work site includes a stop command unit and a first restart command uni. The stop command unit outputs a stop command to stop each of a plurality of unmanned vehicles at the work site. The first restart command unit outputs a first restart command to restart an unmanned vehicle present outside a predetermined range based on a manned vehicle at the work site.

### CROSS-REFERENCE TO RELATED APPLICATIONS

This application is a U.S. National stage application of International Application No. PCT/JP2023/046426, filed on Dec. 25, 2023. This U.S. National stage application claims priority under 35 U.S.C. § 119(a) to Japanese Patent Application No. 2022-208439, filed in Japan on Dec. 26, 2022. The entire contents of Japanese Patent Application No. 2022-208439 is hereby incorporated herein by reference.

### BACKGROUND

### Technical Field

The present disclosure relates to a management system for a work site and a management method for a work site.

### Background Art

An unmanned vehicle operates in a wide-area work site such as a mine. Japanese Laid-Open Patent Publication No. 2017-071946A discloses a technique for emergency stop of all transport vehicles that autonomously travel in a mine.

### SUMMARY

For example, if a manned vehicle is present near an unmanned vehicle, an unexpected situation may occur when a plurality of unmanned vehicles in an emergency stop are restarted all at once. Due to the occurrence of an unexpected situation, productivity at the work site may decrease.

An object of the present disclosure is to suppress a decrease in productivity at the work site.

According to the present disclosure, a management system for a work site is provided, the management system including: a stop command unit that outputs a stop command to stop each of a plurality of unmanned vehicles at a work site; and a first restart command unit that outputs a first restart command to restart an unmanned vehicle present outside a predetermined range based on a manned vehicle at the work site.

According to the present disclosure, a decrease in productivity at the work site is suppressed.

### BRIEF DESCRIPTION OF DRAWINGS

Referring now to the attached drawings which form a part of this original disclosure, an illustrative embodiment is shown.

FIG. 1 is a diagram schematically illustrating a management system for a work site according to an embodiment.

FIG. 2 is a block diagram illustrating the management system for the work site according to the embodiment.

FIG. 3 is a diagram showing the hardware configuration of a management device according to the embodiment.

FIG. 4 is a schematic diagram illustrating travel data of an unmanned dump truck according to the embodiment.

FIG. 5 is a diagram schematically illustrating the work site according to the embodiment.

FIG. 6 is a flowchart illustrating a management method for the work site according to the embodiment.

FIG. 7 is a diagram schematically illustrating the unmanned dump truck in an emergency stop at the work site according to the embodiment.

FIG. 8 is a diagram illustrating an example of display data displayed on a display device according to the embodiment.

FIG. 9 is a diagram schematically illustrating the unmanned dump truck restarted based on a first restart command at the work site according to the embodiment.

FIG. 10 is a diagram illustrating an example of display data displayed on the display device according to the embodiment.

FIG. 11 is a diagram schematically illustrating the unmanned dump truck restarted based on a second restart command at the work site according to the embodiment.

FIG. 12 is a diagram schematically illustrating the work site where a predetermined range is canceled according to the embodiment.

### DETAILED DESCRIPTION OF EMBODIMENT(S)

Hereinafter, an embodiment according to the present disclosure will be described with reference to the drawings, but the present disclosure is not limited to the embodiment. The elements of the embodiment described below can be combined as appropriate. Also, in some cases, some elements are not used.

### Management System

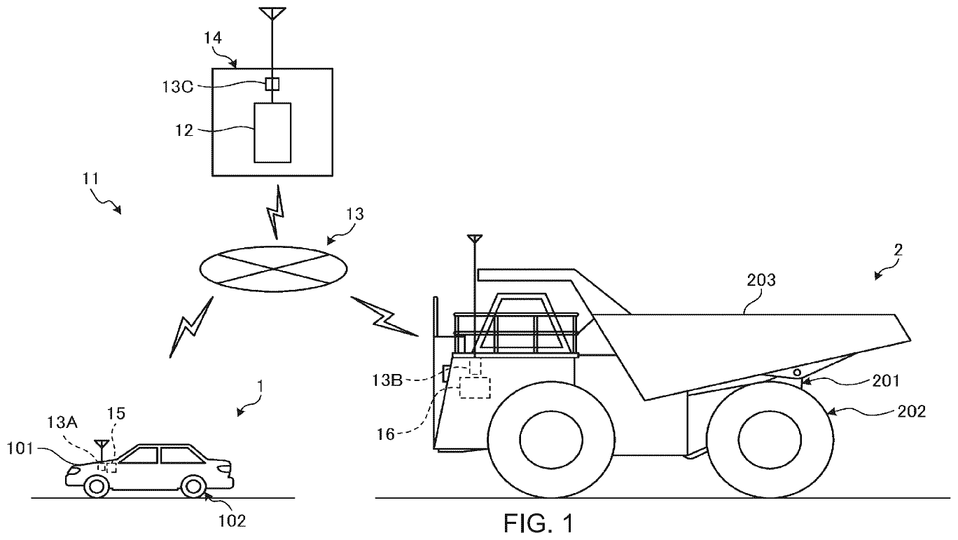

FIG. 1 is a diagram schematically illustrating a management system 11 for a work site according to the embodiment. Examples of the work site include a mine and a quarry. The mine refers to a place or a place of business where minerals are mined. The quarry refers to a place or a place of business where stones are mined. Examples of the mine include a metal mine for mining metal, a non-metal mine for mining limestone, or a coal mine for mining coal.

At the work site, a manned vehicle 1 and an unmanned vehicle 2 operate. A driver gets on board the manned vehicle 1. No driver gets on board the unmanned vehicle 2. The manned vehicle 1 refers to a vehicle that operates based on a driving operation by a driver. The unmanned vehicle 2 refers to a vehicle that operates in an unmanned state without depending on a driving operation by a driver. In the embodiment, the manned vehicle 1 is a lightweight vehicle that travels at the work site. The manned vehicle 1 is used to patrol the work site or transfer a worker. In the embodiment, the manned vehicle 1 is referred to as a manned light vehicle 1, as appropriate. In the embodiment, the unmanned vehicle 2 is a heavy-weight vehicle that travels in an unmanned state at the work site. The unmanned vehicle 2 is a transport vehicle that performs transport work of transporting a load. In the embodiment, the unmanned vehicle 2 is referred to as an unmanned dump truck 2, as appropriate.

The management system 11 includes a management device 12 and a communication system 13. The management device 12 is disposed outside the manned light vehicle 1 and the unmanned dump truck 2. The management device 12 is installed at a control facility 14 in the work site. The management device 12 includes a computer system. Examples of the communication system 13 include the internet, a mobile phone communication network, a satellite communication network, or a local area network (LAN).

The manned light vehicle 1 includes a vehicle body 101, a traveling device 102, a control device 15, and a wireless communication device 13A. The vehicle body 101 includes a vehicle body frame. The vehicle body 101 is supported by the traveling device 102. The traveling device 102 travels, supporting the vehicle body 101. The traveling device 102 includes a wheel, a tire mounted on the wheel, an engine, a brake device, and a steering device. The control device 15 includes a computer system. The wireless communication device 13A is connected to the control device 15.

The unmanned dump truck 2 includes a vehicle body 201, a traveling device 202, a dump body 203, a control device 16, and a wireless communication device 13B. The vehicle body 201 includes a vehicle body frame. The vehicle body 201 is supported by the traveling device 202. The traveling device 202 travels, supporting the vehicle body 201. The traveling device 202 includes a wheel, a tire mounted on the wheel, an engine, a brake device, and a steering device. The dump body 203 is a member on which a load is placed. The dump body 203 is supported by the vehicle body 201. The dump body 203 performs a dumping operation and a lowering operation. The dumping operation refers to an operation of causing the dump body 203 to move away from the vehicle body 201 and incline in a dumping direction. The lowering operation refers to an operation of causing the dump body 203 to approach the vehicle body 201. When loading work is performed, the dump body 203 performs the lowering operation. When discharging work is performed, the dump body 203 performs the dumping operation. The control device 16 includes a computer system. The wireless communication device 13B is connected to the control device 16.

The communication system 13 includes the wireless communication device 13A connected to the control device 15, the wireless communication device 13B connected to the control device 16, and a wireless communication device 13C connected to the management device 12. The management device 12 and the control device 15 of the manned light vehicle 1 wirelessly communicate with each other via the communication system 13. The management device 12 and the control device 16 of the unmanned dump truck 2 wirelessly communicate with each other via the communication system 13.

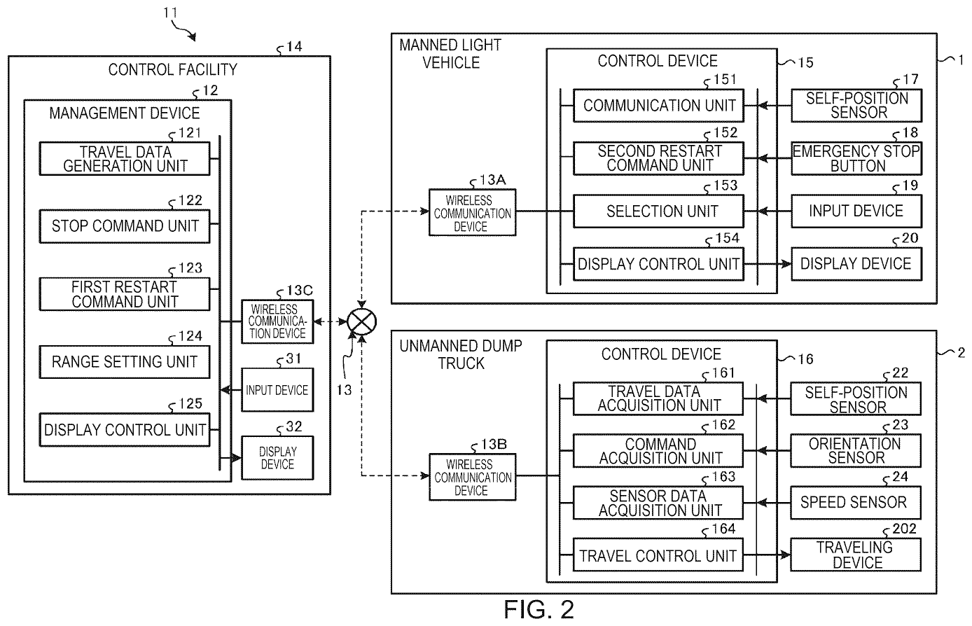

FIG. 2 is a block diagram illustrating the management system 11 for the work site according to the embodiment. The management device 12, the wireless communication device 13C, an input device 31, and a display device 32 are disposed in the control facility 14. Each of the wireless communication device 13C, the input device 31, and the display device 32 is coupled to the management device 12. An administrator is present in the control facility 14. When the input device 31 is operated by the administrator, input data is generated. Examples of the input device 31 include a touch panel, a computer keyboard, and an input button. The display device 32 outputs and provides display data to the administrator. Examples of the display device 32 include a flat panel display such as a liquid crystal display or an organic EL display. The management device 12 includes a travel data generation unit 121, a stop command unit 122, a first restart command unit 123, a range setting unit 124, and a display control unit 125.

The travel data generation unit 121 generates travel data indicating a traveling condition of the unmanned dump truck 2. The travel data generation unit 121 transmits the travel data to the unmanned dump truck 2 via the communication system 13.

The stop command unit 122 outputs a stop command to stop each of a plurality of unmanned dump trucks 2 at the work site. When the stop command is output from the stop command unit 122, all the unmanned dump trucks 2 operating at the work site make an emergency stop. When an emergency stop button 18 of the manned light vehicle 1 is operated by the driver, an emergency stop signal is generated. The emergency stop signal generated by operating the emergency stop button 18 is transmitted to the management device 12 via the communication system 13. The stop command unit 122 outputs a stop command based on the emergency stop signal from the emergency stop button 18 provided in the manned light vehicle 1.

The first restart command unit 123 outputs a first restart command to restart at least a part of the unmanned dump trucks 2 among the plurality of unmanned dump trucks 2 in the emergency stop. In the embodiment, the first restart command unit 123 outputs a first restart command to restart the unmanned dump truck 2 present outside a predetermined range 10 based on the manned light vehicle 1 at the work site. In response to the output of the first restart command from the first restart command unit 123, the plurality of unmanned dump trucks 2 present outside the predetermined range 10 are restarted all at once. The first restart command unit 123 outputs the first restart command based on the input data from the input device 31 coupled to the management device 12.

The range setting unit 124 sets the predetermined range 10. The range setting unit 124 sets the predetermined range 10, based on the input data from the input device 31. The administrator can freely set the predetermined range 10 by operating the input device 31. The range setting unit 124 can set the shape and size of the predetermined range 10, based on the input data from the input device 31.

The display control unit 125 controls the display device 32. The display control unit 125 causes the display device 32 to display the display data. In the embodiment, the display control unit 125 causes the display device 32 to display at least the predetermined range 10.

The manned light vehicle 1 includes the control device 15, the wireless communication device 13A, a self-position sensor 17, the emergency stop button 18, an input device 19, and a display device 20. Each of the wireless communication device 13A, the self-position sensor 17, the emergency stop button 18, the input device 19, and the display device 20 can communicate with the control device 15.

The self-position sensor 17 detects the position of the manned light vehicle 1. The position of the manned light vehicle 1 is detected by using a global navigation satellite system (GNSS). The global navigation satellite system includes the global positioning system (GPS). The global navigation satellite system detects a position in a global coordinate system prescribed by coordinate data of latitude, longitude, and altitude. The global coordinate system refers to a coordinate system fixed to the earth. The self-position sensor 17 includes a GNSS receiver and detects an absolute position of the manned light vehicle 1 indicating a position of the manned light vehicle 1 in the global coordinate system. The emergency stop button 18 is disposed inside the manned light vehicle 1. When the emergency stop button 18 is operated by the driver, all the unmanned dump trucks 2 operating at the work site make an emergency stop. The input device 19 is disposed inside the manned light vehicle 1. When the input device 19 is operated by the driver, input data is generated. Examples of the input device 19 include a touch panel, a computer keyboard, and an input button. The display device 20 is disposed inside the manned light vehicle 1. The display device 20 outputs and provides the display data to the driver. Examples of the display device 20 include a flat panel display such as a liquid crystal display or an organic EL display. The control device 15 includes a communication unit 151, a second restart command unit 152, a selection unit 153, and a display control unit 154.

The communication unit 151 transmits the detection data of the self-position sensor 17 to the management device 12. The communication unit 151 transmits the emergency stop signal generated at the emergency stop button 18 to the management device 12. The communication unit 151 transmits the second restart command output from the second restart command unit 152 to the unmanned dump truck 2.

The second restart command unit 152 outputs a second restart command to restart at least a part of the unmanned dump trucks 2 among the plurality of unmanned dump trucks 2 in the emergency stop. In the embodiment, the second restart command unit 152 outputs a second restart command to restart the unmanned dump truck 2 present inside the predetermined range 10 based on the manned light vehicle 1 at the work site. The second restart command part 152 outputs the second restart command, based on the input data from the input device 19 provided in the manned light vehicle 1. The second restart command unit 152 outputs the second restart command to restart the unmanned dump truck 2 present inside the predetermined range 10 after the unmanned dump truck 2 present outside the predetermined range 10 is restarted, based on the first restart command.

The selection unit 153 selects the unmanned dump truck 2 to be restarted from the plurality of unmanned dump trucks 2 present inside the predetermined range 10, based on the input data from the input device 19. The second restart command unit 152 restarts the specific unmanned dump truck 2 selected by the selection unit 153. The plurality of unmanned dump trucks 2 present inside the predetermined range 10 are selectively restarted in response to the output of the second restart command from the second restart command unit 152.

The display control unit 154 controls the display device 20. The display control unit 154 causes the display device 20 to display the display data. In the embodiment, the display control unit 154 causes the display device 20 to display at least the predetermined range 10.

The unmanned dump truck 2 includes the control device 16, the wireless communication device 13B, a self-position sensor 22, an orientation sensor 23, a speed sensor 24, and the traveling device 202. Each of the wireless communication device 13B, the self-position sensor 22, the orientation sensor 23, and the speed sensor 24 can communicate with the control device 16. The traveling device 202 is controlled by the control device 16.

The self-position sensor 22 detects the position of the unmanned dump truck 2. The self-position sensor 22 includes a GNSS receiver and detects an absolute position of the unmanned dump truck 2 indicating the position of the unmanned dump truck 2 in the global coordinate system. The orientation sensor 23 detects the orientation of the unmanned dump truck 2. Examples of the orientation sensor 23 include a gyro sensor. The speed sensor 24 detects the traveling speed of the unmanned dump truck 2. Examples of the speed sensor 24 include a pulse sensor that detects the rotation of the wheel of the unmanned dump truck 2. The control device 16 includes a travel data acquisition unit 161, a command acquisition unit 162, a sensor data acquisition unit 163, and a travel control unit 164.

The travel data acquisition unit 161 acquires the travel data of the unmanned dump truck 2 generated by the travel data generation unit 121 via the communication system 13. The command acquisition unit 162 acquires the stop command output from the stop command unit 122 via the communication system 13. The command acquisition unit 162 acquires the first restart command output from the first restart command unit 123 or the second restart command output from the second restart command unit 152 via the communication system 13. The sensor data acquisition unit 163 acquires detection data of the self-position sensor 22, detection data of the orientation sensor 23, and detection data of the speed sensor 24.

The travel control unit 164 controls the traveling device 202, based on the travel data of the unmanned dump truck 2 acquired by the travel data receiving unit 161 and the detection data acquired by the sensor data acquisition unit 163. The travel control unit 164 causes the traveling device 202 to make an emergency stop, based on the stop command acquired by the stop command unit 122. The travel control unit 164 restarts the traveling device 202 in the emergency stop, based on the first restart command or the second restart command acquired by the stop command unit 122.

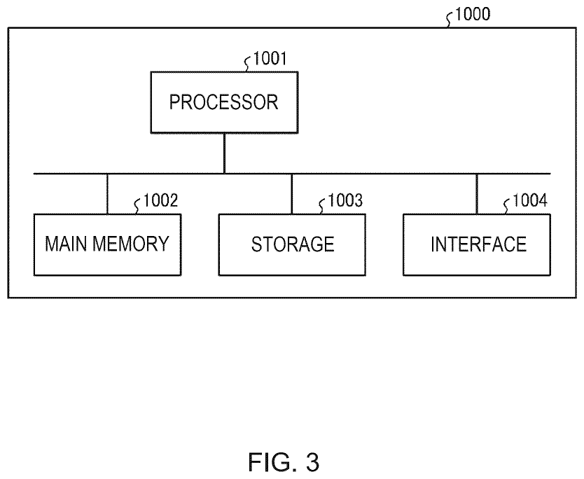

FIG. 3 is a diagram showing the hardware configuration of the management device 12 according to the embodiment. The management device 12 includes a computer system 1000. The computer system 1000 includes a processor 1001 such as a central processing unit (CPU), a main memory 1002 including a nonvolatile memory such as a read-only memory (ROM) and a volatile memory such as a random-access memory (RAM), a storage 1003, and an interface 1004 including an input/output circuit. The above functions of the management device 12 are stored as a computer program in the storage 1003. The processor 1001 reads out the computer program from the storage 1003, loads the computer program into the main memory 1002, and executes the above processing in accordance with the program. Note that the computer program may be distributed to the computer system 1000 via a network. Each of the control device 15 and the control device 16 also includes a computer system 1000 as illustrated in FIG. 3. The functions of each of the control device 15 and the control device 16 described above are stored in the storage 1003 as a computer program.

### Travel Data

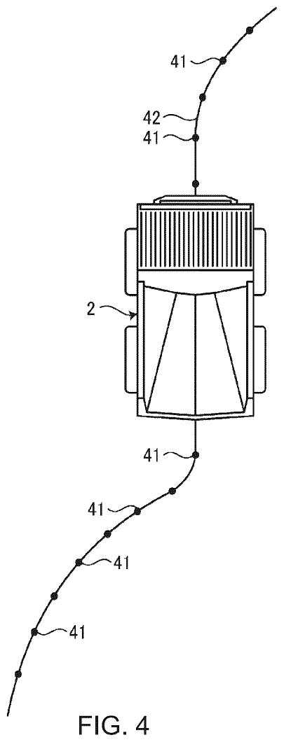

FIG. 4 is a schematic diagram illustrating the travel data of the unmanned dump truck 2 according to the embodiment. The travel data of the unmanned dump truck 2 prescribes a traveling condition of the unmanned dump truck 2. The travel data of the unmanned dump truck 2 includes a traveling point 41, a traveling path 42, a target position of the unmanned dump truck 2, a target orientation of the unmanned dump truck 2, and a target traveling speed of the unmanned dump truck 2. The travel data of the unmanned dump truck 2 including the traveling path 42 is generated by the travel data generation unit 121.

A plurality of traveling points 41 are set in the work site. The traveling point 41 prescribes a target position of the unmanned dump truck 2. A target orientation of the unmanned dump truck 2 and a target traveling speed of the unmanned dump truck 2 are set for each of the plurality of traveling points 41. The plurality of traveling points 41 are set at intervals. The interval between the traveling points 41 may be uniform or non-uniform. The traveling path 42 refers to an imaginary line indicating the target traveling route of the unmanned dump truck 2. The traveling path 42 is prescribed by a trajectory of passage through the plurality of traveling points 41. The unmanned dump truck 2 travels along the traveling path 42 at the work site. The unmanned dump truck 2 travels such that the center of the unmanned dump truck 2 and the traveling path 42 coincide with each other in the vehicle width direction of the unmanned dump truck 2. The target position of the unmanned dump truck 2 refers to the target position of the unmanned dump truck 2 when passing through the traveling point 41. The target position of the unmanned dump truck 2 may be prescribed in a local coordinate system of the unmanned dump truck 2 or may be prescribed in a global coordinate system. The target orientation of the unmanned dump truck 2 refers to the target orientation of the unmanned dump truck 2 when passing through the traveling point 41. The target traveling speed of the unmanned dump truck 2 refers to the target traveling speed of the unmanned dump truck 2 when passing through the traveling point 41.

### Work Site

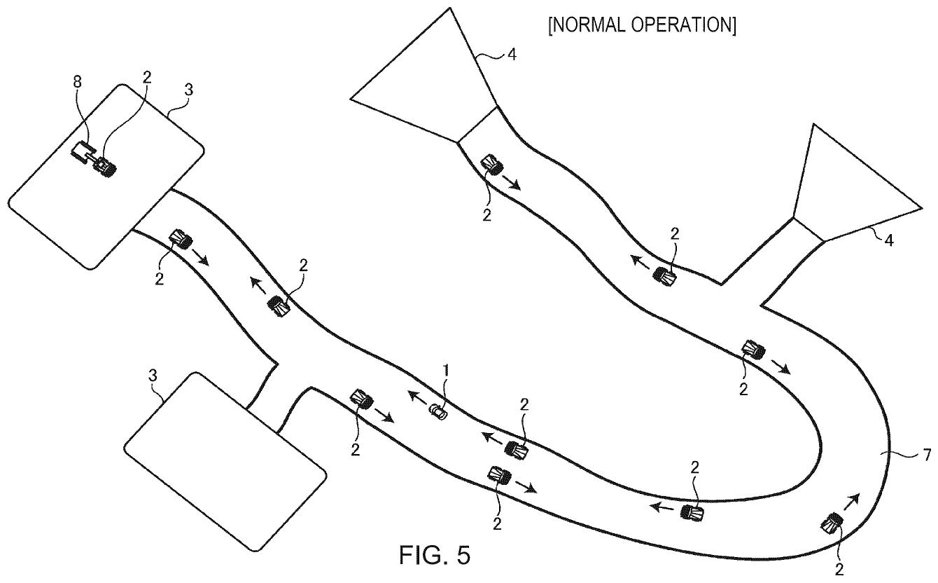

FIG. 5 is a diagram schematically illustrating the work site according to the embodiment. The work site includes a loading area 3, a discharging area 4, and a traveling track 7. The loading area 3 refers to an area where loading work of placing a load on the unmanned dump truck 2 is performed. Examples of the load include an excavated material excavated in the loading area 3. In the loading area 3, a loader 8 operates. Examples of the loader 8 include a hydraulic shovel. An operator gets on board the loader 8. The loader 8 is a manned vehicle that operates based on an operation by an operator. The discharging area 4 refers to an area where discharging work of discharging a load from the unmanned dump truck 2 is performed. The traveling track 7 refers to an area where the unmanned dump truck 2 travels. The traveling track 7 is provided so as to connect at least the loading area 3 and the discharging area 4. The manned light vehicle 1 can travel in each of the loading area 3, the discharging area 4, and the traveling track 7. The unmanned dump truck 2 can travel in each of the loading area 3, the discharging area 4, and the traveling track 7. The unmanned dump truck 2 travels in the traveling track 7, for example, so as to move to and from the loading area 3 and the discharging area 4.

FIG. 5 schematically illustrates a state where the unmanned dump truck 2 is normally operating. In the normal operation, the unmanned dump truck 2 travels at the work site, based on the travel data. The travel control unit 164 controls the traveling device 202 such that the unmanned dump truck 2 travels along the traveling path 42, based on the travel data of the unmanned dump truck 2 and the detection data acquired by the sensor data acquisition unit 163. The travel control unit 164 controls the traveling device 202 such that the deviation between the detected position of the unmanned dump truck 2 detected by the self-position sensor 22 when passing through the traveling point 41 and the target position of the unmanned dump truck 2 set for the traveling point 41 decreases. The travel control unit 164 controls the traveling device 202 such that the deviation between the detected orientation of the unmanned dump truck 2 detected by the orientation sensor 23 when passing through the traveling point 41 and the target orientation of the unmanned dump truck 2 set for the traveling point 41 decreases. The travel control unit 164 controls the traveling device 202 such that the deviation between the detected traveling speed of the unmanned dump truck 2 detected by the speed sensor 24 when passing through the traveling point 41 and the target traveling speed of the unmanned dump truck 2 set for the traveling point 41 decreases.

### Management Method

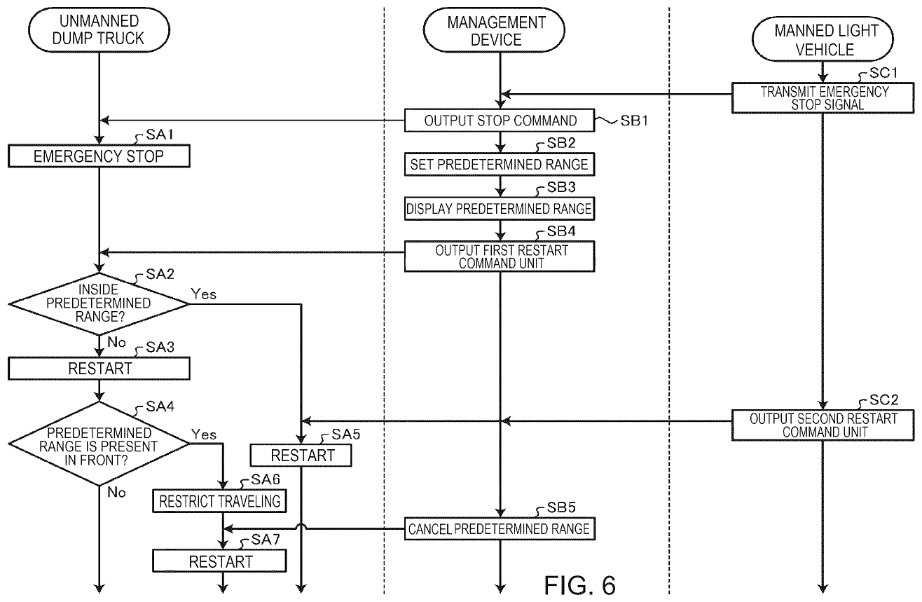

FIG. 6 is a flowchart illustrating a management method for the work site according to the embodiment. When the driver of the manned light vehicle 1 confirms the occurrence of an event that requires an emergency stop of the unmanned dump truck 2 in a state where each of the manned light vehicle 1 and the unmanned dump truck 2 normally operates at the work site, the driver of the manned light vehicle 1 operates the emergency stop button 18. When the emergency stop button 18 is operated by the driver of the manned light vehicle 1, the communication unit 151 transmits an emergency stop signal generated by the operation of the emergency stop button 18 to the management device 12 (step SC1). The stop command unit 122 outputs a stop command to cause all of the plurality of unmanned dump trucks 2 at the work site to make an emergency stop, based on the emergency stop signal from the emergency stop button 18 provided in the manned light vehicle 1 (step SB1).

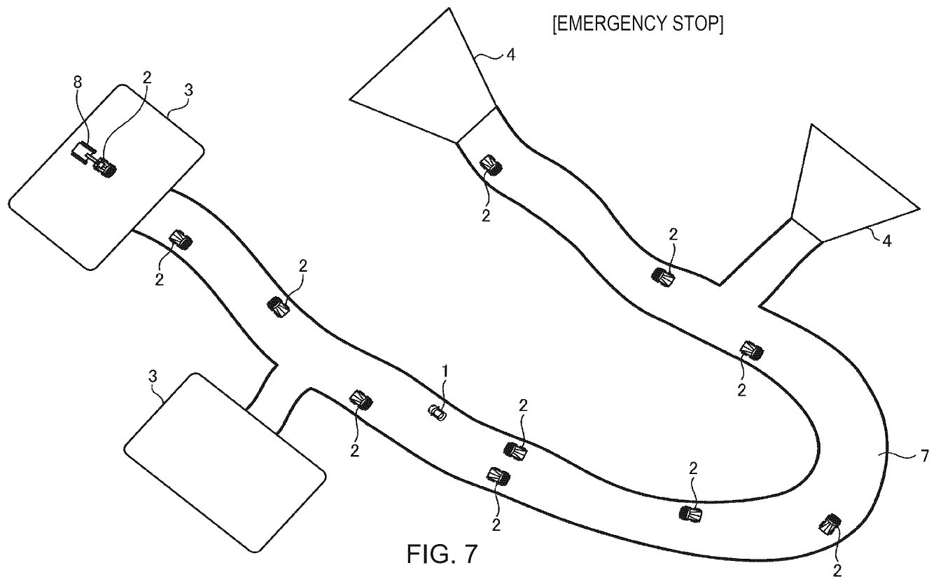

FIG. 7 is a diagram schematically illustrating the unmanned dump truck 2 in an emergency stop at the work site according to the embodiment. The command acquisition unit 162 of the unmanned dump truck 2 acquires the stop command from the management device 12. The travel control unit 164 causes the traveling device 202 to make an emergency stop, based on the stop command. Each of the plurality of unmanned dump trucks 2 stops at the position when the stop command is received. As illustrated in FIG. 7, each of the plurality of unmanned dump trucks 2 normally operating at the work site makes an emergency stop, based on the stop command (step SA1).

The administrator present in the control facility 14 operates the input device 31 to set the predetermined range 10. The administrator can set the shape and size of the predetermined range 10 by operating the input device 31. The range setting unit 124 sets the predetermined range 10, based on the input data from the input device 31 (step SB2). The display control unit 125 causes the display device 32 to display the predetermined range 10 (step SB3).

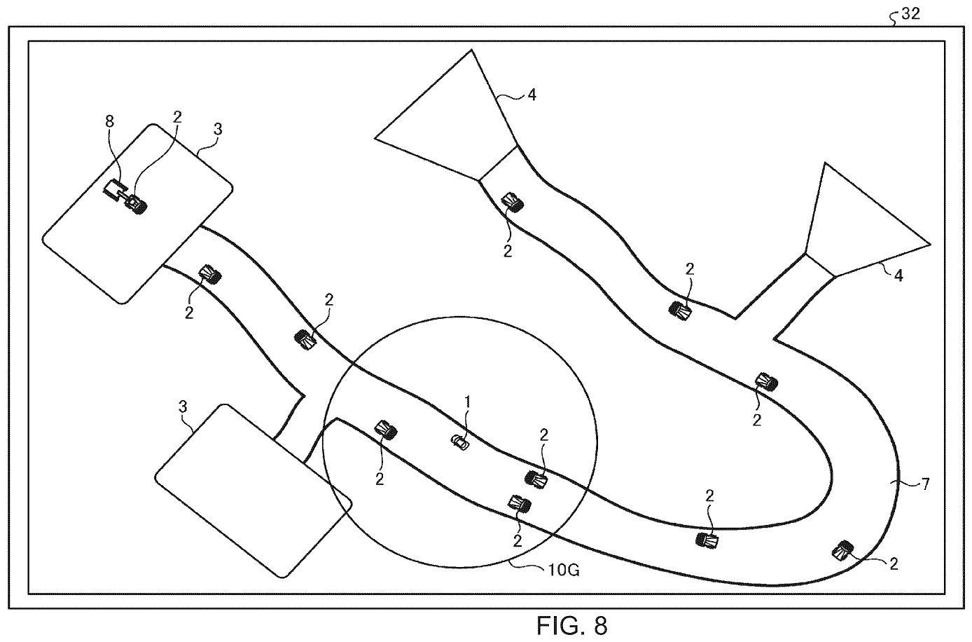

FIG. 8 is a diagram illustrating an example of display data displayed on the display device 32 according to the embodiment. As illustrated in FIG. 8, image data 10G showing the predetermined range 10 set by the range setting unit 124 is displayed on the display device 32. The administrator can set the predetermined range 10 by operating the input device 31 while checking the image data 10G displayed on the display device 32. In the embodiment, the display device 32 displays map data of the work site, a symbol indicating the manned light vehicle 1, and a symbol indicating each of the plurality of unmanned dump trucks 2. The display control unit 125 can display the symbol of the manned light vehicle 1 at a position corresponding to the actual position of the manned light vehicle 1 in the map data of the work site, based on the detection data of the self-position sensor 17. The display control unit 125 can display the symbol of the unmanned dump truck 2 at a position corresponding to the actual position of the unmanned dump truck 2 in the map data of the work site, based on the detection data of the self-position sensor 22. The display control unit 125 can display the image data 10G so as to be superimposed on the map data of the work site, the symbol indicating the manned light vehicle 1, and the symbol of the unmanned dump truck 2. The predetermined range 10 is set such that the manned light vehicle 1 is disposed inside the predetermined range 10. The predetermined range 10 is set, based on the manned light vehicle 1. In the embodiment, the predetermined range 10 is set such that the manned light vehicle 1 is disposed at the center of the predetermined range 10. The predetermined range 10 is set in a circular shape centered on the manned light vehicle 1. The diameter of the predetermined range 10 is set to, for example, 50 m or more and 500 m or less.

After confirming the elimination of the event requiring the emergency stop of the unmanned dump truck 2, the administrator operates the input device 31 to restart the unmanned dump truck 2 outside the predetermined range 10. The first restart command unit 123 outputs the first restart command to restart the unmanned dump truck 2 present outside the predetermined range 10 to the unmanned dump truck 2, based on the input data from the input device 31 (step SB4). The command acquisition unit 162 of the unmanned dump truck 2 acquires the first restart command from the management device 12.

The position data of the predetermined range 10 set in step SB2 is transmitted from the range setting unit 124 to the control device 16 of the unmanned dump truck 2. The travel control unit 164 of each of the plurality of unmanned dump trucks 2 determines whether the unmanned dump truck 2 (host vehicle) is present inside the predetermined range 10, based on the detection data of the self-position sensor 22 and the position data of the predetermined range 10 (step SA2). If it is determined in step SA2 that the unmanned dump truck 2 is present outside the predetermined range 10 (Yes in step SA2), the travel control unit 164 restarts the traveling by the traveling device 202. The travel control unit 164 causes the traveling device 202 to travel, based on the travel data. The unmanned dump truck 2 present outside the predetermined range 10 is restarted (step SA3).

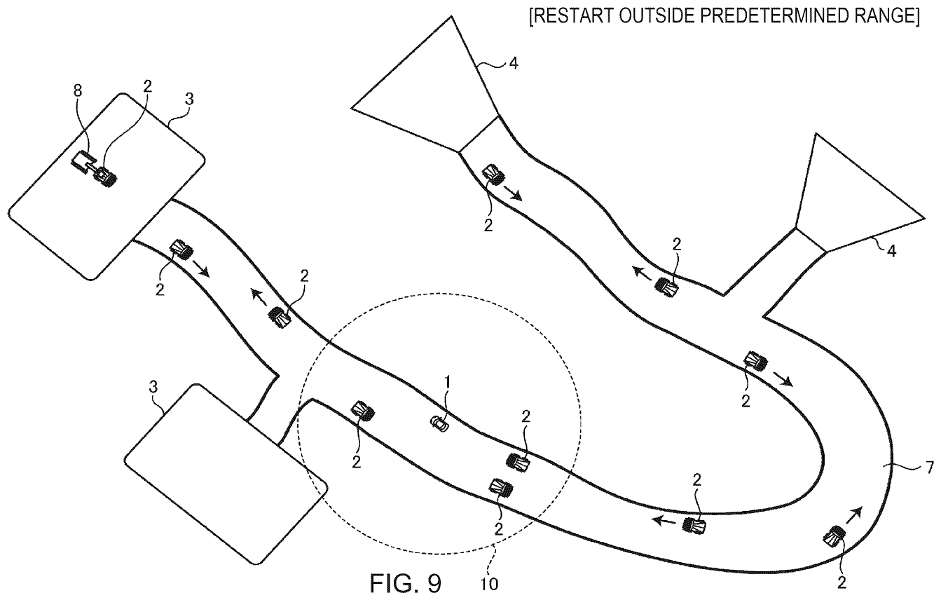

FIG. 9 is a diagram schematically illustrating the unmanned dump truck 2 restarted, based on the first restart command at the work site according to the embodiment. As illustrated in FIG. 9, the unmanned dump truck 2 outside the predetermined range 10 is restarted, based on the first restart command. In response to the output of the first restart command, the plurality of unmanned dump trucks 2 present outside the predetermined range 10 are restarted all at once. If the second restart command is not output even when the first restart command is output, the plurality of unmanned dump trucks 2 present inside the predetermined range 10 are not restarted.

After the unmanned dump truck 2 present outside the predetermined range 10 is restarted, the driver of the manned light vehicle 1 checks the situation around the manned light vehicle 1. After confirming that it is a situation where the unmanned dump truck 2 present inside the predetermined range 10 may be restarted, the driver of the manned light vehicle 1 operates the input device 19 to restart the unmanned dump truck 2 inside the predetermined range 10. The second restart command unit 152 outputs the second restart command to restart the unmanned dump truck 2 present inside the predetermined range 10 to the unmanned dump truck 2 present inside the predetermined range 10 (step SC2). The command acquisition unit 162 of the unmanned dump truck 2 acquires the second restart command from the control device 15.

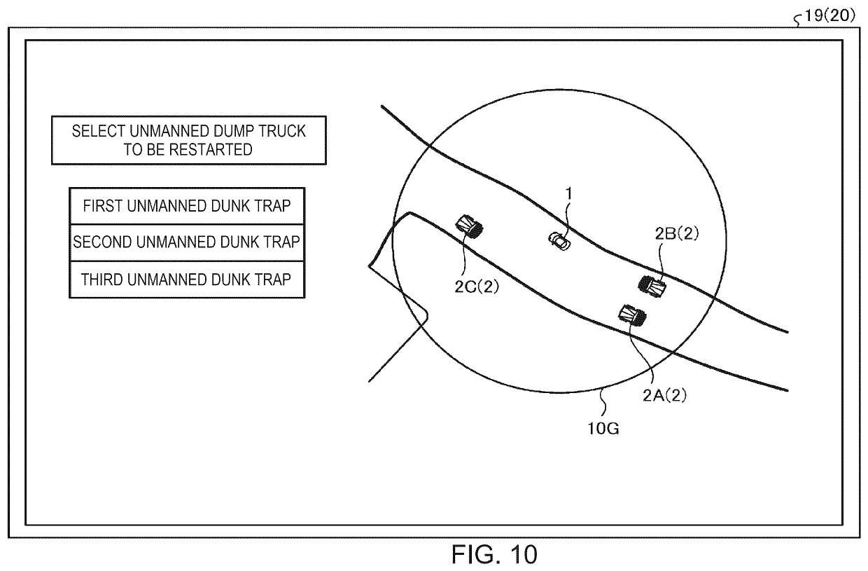

FIG. 10 is a diagram illustrating an example of display data displayed on the display device 20 according to the embodiment. As illustrated in FIG. 10, the image data 10G showing the predetermined range 10 set by the range setting unit 124 is displayed on the display device 20. The display device 20 displays the predetermined range 10 and map data of the work site near the predetermined range 10, a symbol indicating the manned light vehicle 1, and a symbol indicating each of the plurality of unmanned dump trucks 2. The display control part 154 can display the symbol of the manned light vehicle 1 at a position corresponding to the actual position of the manned light vehicle 1 in the map data of the work site, based on the detection data of the self-position sensor 17. The display control unit 154 can display the symbol of the unmanned dump truck 2 at a position corresponding to the actual position of the unmanned dump truck 2 in the map data of the work site, based on the detection data of the self-position sensor 22. The display control unit 154 can display the image data 10G so as to be superimposed on the map data of the work site, the symbol indicating the manned light vehicle 1, and the symbol of the unmanned dump truck 2.

The display control unit 154 causes the display device 20 to display a selection screen for allowing the driver to select the unmanned dump truck 2 to be restarted from the plurality of unmanned dump trucks 2 present inside the predetermined range 10. In the embodiment, it is assumed that a first unmanned dump truck 2A, a second unmanned dump truck 2B, and a third unmanned dump truck 2C are present inside the predetermined range 10. The display device 20 displays a selection screen for allowing the driver to select the unmanned dump truck 2 to be restarted from the three unmanned dump trucks 2 (2A, 2B, and 2C) present inside the predetermined range 10. The driver operates the input device 19 to select the unmanned dump truck 2 to be restarted while checking the situation around the manned light vehicle 1. For example, if the input device 19 is operated by the driver so that the first unmanned dump truck 2A is selected, the selection unit 153 selects the first unmanned dump truck 2A to be restarted from the plurality of unmanned dump trucks 2 (2A, 2B, and 2C) present inside the predetermined range 10, based on the input data from the input device 19. The second restart command unit 152 outputs the second restart command so that the first unmanned dump truck 2A selected by the selection unit 153 is restarted. The command acquisition unit 162 of the first unmanned dump truck 2A acquires the second restart command from the control device 15. The travel control unit 164 of the first unmanned dump truck 2A restarts the traveling by the traveling device 202, based on the second restart command. The travel control unit 164 causes the traveling device 202 to travel, based on the travel data. The first unmanned dump truck 2A present inside the predetermined range 10 is restarted (Step SA5).

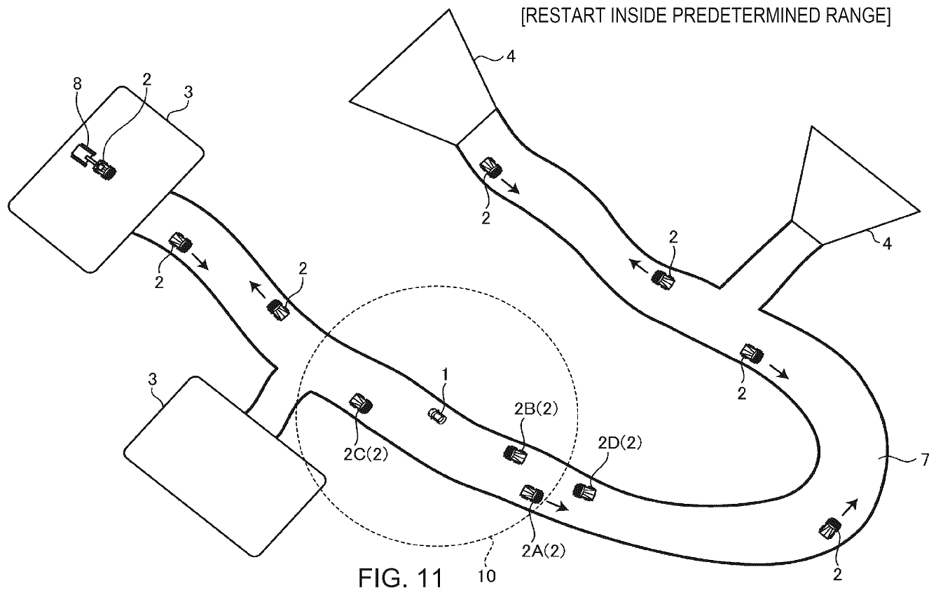

FIG. 11 is a diagram schematically illustrating the unmanned dump truck 2 restarted, based on the second restart command at the work site according to the embodiment. As illustrated in FIG. 11, the first unmanned dump truck 2A inside the predetermined range 10 is restarted, based on the second restart command. The second and third unmanned dump trucks 2B and 2C inside the predetermined range 10 are not selected by the selection unit 153 and therefore are not restarted.

In the embodiment, if the unmanned dump truck 2 that is not restarted is present inside the predetermined range 10, the traveling of the unmanned dump truck 2 entering the inside from the outside of the predetermined range 10 is restricted. In the example illustrated in FIG. 11, a fourth unmanned dump truck 2D restarted based on the first restart command travels toward the predetermined range 10. Since the second and third unmanned dump trucks 2B and 2C that are not restarted are present inside the predetermined range 10, the traveling of the fourth unmanned dump truck 2D traveling so as to enter the inside from the outside of the predetermined range 10 is restricted. That is, the traveling of the fourth unmanned dump truck 2D is restricted such that the fourth unmanned dump truck 2D does not enter the inside of the predetermined range 10. As described above, the position data of the predetermined range 10 set in step SB2 is transmitted from the range setting unit 124 to the control device 16 of the unmanned dump truck 2. The travel control unit 164 of the fourth unmanned dump truck 2D calculates the relative position between the fourth unmanned dump truck 2D (host vehicle) and the predetermined range 10, based on the detection data of the self-position sensor 22 and the position data of the predetermined range 10. The travel control unit 164 of the fourth unmanned dump truck 2D determines whether the predetermined range 10 is present in front of the fourth unmanned dump truck 2D (step SA4). If it is determined in step SA4 that the predetermined range 10 is present in front of the fourth unmanned dump truck 2D and that the fourth unmanned dump truck 2D is approaching the predetermined range 10 (Yes in step SA4), the travel control unit 164 restricts the traveling of the traveling device 202 of the fourth unmanned dump truck 2D (step SA6). The travel control unit 164 stops the fourth unmanned dump truck 2D before the predetermined range 10 so that the fourth unmanned dump truck 2D does not enter the predetermined range 10. If it is determined in step SA4 that the predetermined range 10 is not present in front of the fourth unmanned dump truck 2D (No in step SA4), the travel control unit 164 causes the fourth unmanned dump truck 2D to continue traveling, based on the travel data.

After restarting the first unmanned dump truck 2A, the driver operates the input device 19 to restart the plurality of unmanned dump trucks 2 present inside the predetermined range 10, one by one, while checking the situation around the manned light vehicle 1. The second restart command unit 152 restarts the specific unmanned dump truck 2 selected from the plurality of unmanned dump trucks 2 present inside the predetermined range 10, one by one, based on the input data from the input device 19. For example, if the second unmanned dump truck 2B is selected as the unmanned dump truck 2 to be restarted next to the first unmanned dump truck 2A, based on the input data from the input device 19, the second restart command unit 152 outputs the second restart command so that the second unmanned dump truck 2B is restarted. If the third unmanned dump truck 2C is selected as the unmanned dump truck 2 to be restarted next to the second unmanned dump truck 2B, the second restart command unit 152 outputs the second restart command so that the third unmanned dump truck 2C is restarted.

The range setting unit 124 cancels the predetermined range 10 after all the unmanned dump trucks 2 present inside the predetermined range 10 are restarted. After all the unmanned dump trucks 2B present inside the predetermined range 10 are restarted, the first restart command unit 123 outputs a cancellation command to cancel the restriction on the traveling of the fourth unmanned dump truck 2D to the fourth unmanned dump truck 2D (step SB5).

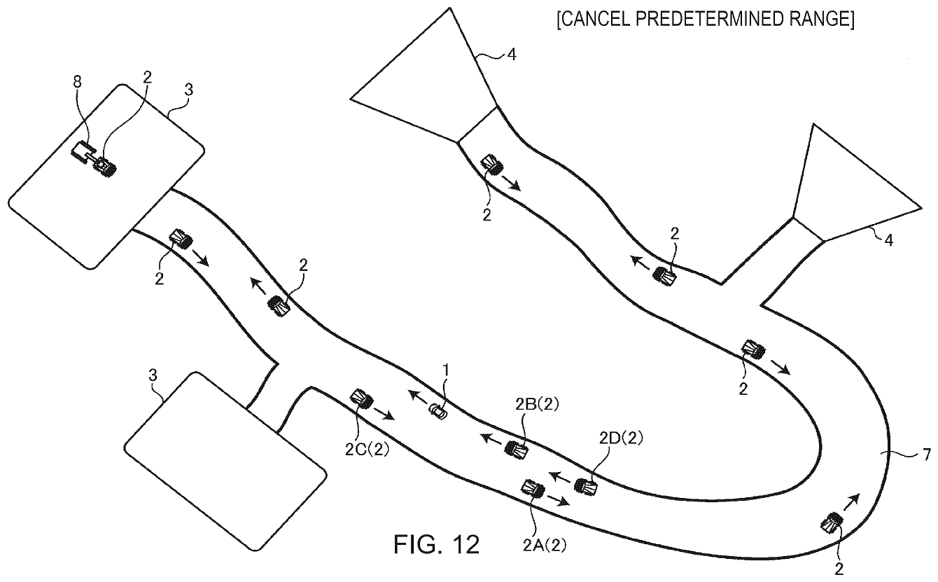

FIG. 12 is a diagram schematically illustrating the work site where the predetermined range 10 is canceled according to the embodiment. As illustrated in FIG. 12, after all the unmanned dump trucks 2 present inside the predetermined range 10 are restarted, the predetermined range 10 is canceled. The travel control unit 164 of the fourth unmanned dump truck 2D whose traveling is restricted in step SA6 restarts the traveling by the traveling device 202, based on the cancellation command from the first restart command unit 123. The travel control unit 164 causes the traveling device 202 of the fourth unmanned dump truck 2D to travel, based on the travel data (step SA7).

### Effects

As described above, according to the embodiment, the management system 11 includes the stop command unit 122, which outputs the stop command to cause each of the plurality of unmanned dump trucks 2 at the work site to make an emergency stop, and the first restart command unit 123, which outputs the first restart command to restart the unmanned dump truck 2 present outside the predetermined range 10 based on the manned light vehicle 1 at the work site.

According to the embodiment, after all of the plurality of unmanned dump trucks 2 at the work site make an emergency stop, the unmanned dump truck 2 present outside the predetermined range 10 based on the manned light vehicle 1 is restarted, and the unmanned dump truck 2 present inside the predetermined range 10 is not restarted. Since the unmanned dump truck 2 present at a position far from the manned light vehicle 1 is restarted and the unmanned dump truck 2 present near the manned light vehicle 1 is not restarted, the occurrence of an unexpected situation is suppressed. Since the occurrence of an unexpected situation is suppressed, a decrease in productivity at the work site is suppressed.

The stop command unit 122 outputs the stop command, based on the stop signal from the emergency stop button 18 provided in the manned light vehicle 1. When the driver of the manned light vehicle 1 confirms the occurrence of an event that requires an emergency stop of the unmanned dump truck 2, the emergency stop button 18 is operated by the driver. The stop command unit 122 can cause the unmanned dump truck 2 to make an emergency stop, based on the intention of the driver.

The first restart command unit 123 outputs the first restart command, based on the input data from the input device 31. When the administrator confirms an event that requires an emergency stop of the unmanned dump truck 2, the input device 31 is operated by the administrator. The first restart command unit 123 can restart the unmanned dump truck 2 outside the predetermined range 10, based on the intention of the administrator.

In response to the output of the first restart command, the plurality of unmanned dump trucks 2 present outside the predetermined range 10 are restarted all at once. Since the plurality of unmanned dump trucks 2 present outside the predetermined range 10 are restarted all at once, a decrease in productivity at the work site is suppressed. Also, the time and effort of restarting the unmanned dump trucks 2 present outside the predetermined range 10 one by one is saved.

The second restart command unit 152 outputs the second restart command to restart the unmanned dump truck 2 present inside the predetermined range 10. Since the unmanned dump truck 2 present inside the predetermined range 10 is restarted after the unmanned dump truck 2 present outside the predetermined range 10 is restarted, the occurrence of an unexpected situation is suppressed and a decrease in productivity at the work site is suppressed.

The second restart command part 152 outputs the second restart command, based on the input data from the input device 19 provided in the manned light vehicle 1. When the driver of the manned light vehicle 1 confirms that it is a situation where the unmanned dump truck 2 present inside the predetermined range 10 may be restarted, the driver operates the input device 19. The second restart command unit 152 can restart the unmanned dump truck 2 inside the predetermined range 10, based on the intention of the driver.

The second restart command unit 152 restarts the specific unmanned dump truck 2 selected from the plurality of unmanned dump trucks 2 present inside the predetermined range 10, based on the input data from the input device 19. If the plurality of unmanned dump trucks 2 inside the predetermined range 10 are restarted all at once, an unexpected situation may occur. As the unmanned dump trucks 2 inside the predetermined range 10 are restarted one by one while the situation around the manned light vehicle 1 is checked, the occurrence of an unexpected situation is suppressed.

If the unmanned dump truck 2 that is not restarted is present inside the predetermined range 10, the traveling of the unmanned dump truck 2 that travels so as to enter the inside from the outside of the predetermined range 10 is restricted. Thus, the unmanned dump truck 2 stopped inside the predetermined range 10 and the unmanned dump truck 2 already restarted are prevented from approaching or coming into contact with each other.

The first restart command unit 123 cancels the restriction on the unmanned dump truck 2 whose traveling is restricted, after all the unmanned dump trucks 2 present inside the predetermined range 10 are restarted. Thus, a decrease in productivity at the work site is suppressed while the occurrence of an unexpected situation is suppressed.

The range setting unit 124 sets the predetermined range 10, based on the input data from the input device 31. The input device 31 is operated by the administrator. The range setting unit 124 can set the predetermined range 10, based on the intention of the administrator. Since the predetermined range 10 is displayed on the display device 32, the administrator can set the predetermined range 10 while checking the predetermined range 10 (image data 10G) displayed on the display device 32.

### Other Embodiments

In the above-described embodiment, the manned vehicle having the emergency stop button 18 is the manned light vehicle. The manned vehicle having the emergency stop button 18 may be the loader 8 or a work machine different from the loader 8.

In the above embodiment, the unmanned vehicle is the unmanned dump truck 2. The unmanned vehicle may be, for example, an unmanned sprinkler truck.

In the above embodiment, at least a part of the functions of the control device 15 may be provided in the management device 12, or at least a part of the functions of the management device 12 may be provided in the control device 15. For example, in the above-described embodiment, the management device 12 may have the functions of the second restart command unit 152 and the selection unit 153. The control device 15 may have the functions of the stop command unit 122, the first restart command unit 123, and the range setting unit 124. Similarly, at least a part of the functions of the control device 16 may be provided in the management device 12, or at least a part of the functions of the management device 12 may be provided in the control device 16.

In the above embodiment, a plurality of functions of the management device 12 may be configured with separate pieces of hardware. That is, the travel data generation unit 121, the stop command unit 122, the first restart command unit 123, the range setting unit 124, and the display control unit 125 may be configured with separate pieces of hardware. Similarly, a plurality of functions of the control device 15 may be configured with separate pieces of hardware, or a plurality of functions of the control device 16 may be configured with separate pieces of hardware.

1. A management system for a work site comprising:
a processor configured to
output a stop command to stop each of a plurality of unmanned vehicles at a work site, and
output a first restart command to restart an unmanned vehicle present outside a predetermined range based on a manned vehicle at the work site.

2. The management system for the work site according to claim 1, wherein
the processor is configured to output the stop command, based on a stop signal from a stop operation device provided in the manned vehicle.

3. The management system for the work site according to claim 1, wherein
the processor is configured to output the first restart command, based on input data from an input device.

4. The management system for the work site according to claim 1, wherein
a plurality of unmanned vehicles present outside the predetermined range are restarted all at once in response to the output of the first restart command.

5. The management system for the work site according to claim 1, wherein
the processor is further configured to output a second restart command to restart the unmanned vehicle present inside the predetermined range.

6. The management system for the work site according to claim 5, wherein
the processor is configured to output the second restart command, based on input data from an input device provided in the manned vehicle.

7. The management system for the work site according to claim 6, wherein
the processor is configured to restart a specific unmanned vehicle selected from a plurality of unmanned vehicles present inside the predetermined range, based on the input data from the input device.

8. The management system for the work site according to claim 7, wherein
the processor is configured to output the second restart command after an unmanned vehicle present outside the predetermined range is restarted.

9. The management system for the work site according to claim 8, wherein
if an unmanned vehicle that is not restarted is present inside the predetermined range, traveling of an unmanned vehicle that travels so as to enter an inside from an outside of the predetermined range is restricted.

10. The management system for the work site according to claim 9, wherein
the processor is configured to cancel the restriction after all unmanned vehicles present inside the predetermined range are restarted.

11. The management system for the work site according to claim 1, wherein
the processor is further configured to set the predetermined range, based on input data from an input device.

12. The management system for the work site according to claim 1, wherein
the processor is further configured to cause a display device to display the predetermined range.

13. A management method for a work site, the method comprising:
outputting a stop command to stop each of a plurality of unmanned vehicles at a work site; and
outputting a first restart command to restart an unmanned vehicle present outside a predetermined range based on a manned vehicle at the work site.
